(19) United States
(12) Patent Application Publication
(10) Pub. No.: US 2025/0362406 A1
(43) Pub. Date: Nov. 27, 2025

(54) HARMONIC RADAR FOR WIRELESS BATTERY DETECTION

(71) Applicant: The Trustees of Dartmouth College, Hanover, NH (US)

(72) Inventors: Cesar Arguello, Hanover, NH (US); Beatrice Perez, Hanover, NH (US); Timothy Pierson, Hanover, NH (US); David Kotz, Hanover, NH (US)

(21) Appl. No.: 19/216,352

(22) Filed: May 22, 2025

Related U.S. Application Data
(60) Provisional application No. 63/651,278, filed on May 23, 2024.

(51) Int. Cl. G01S 13/88; G01S 7/282; G01S 7/292; G01S 7/41; G01S 13/76

(52) U.S. Cl. CPC G01S 13/887; G01S 7/282; G01S 7/292; G01S 7/41; G01S 13/76

(57) ABSTRACT

A harmonic radar system for detecting a battery may include a signal generator for generating one or more transmit radio frequency (RF) signals, one or more low-pass filters for removing harmonics from the transmit RF signals, a transmitting antenna for sending the transmit RF signals into an environment, a receiving antenna for receiving signals reflected or re-radiated by the battery in the environment in response to the transmit RF signals, one or more high-pass filters for filtering the received signals, and a spectrum analyzer for identifying a harmonic frequency of the transmit RF signals in the filtered signals.

### CROSS REFERENCE TO RELATED APPLICATIONS

This application claims priority to U.S. Provisional Application No. 63/651,278 filed May 23, 2024, incorporated herein by reference in its entirety.

### U.S. GOVERNMENT RIGHTS

The U.S. Government has certain rights in this invention as provided for by the terms provided by the U.S. National Science Foundation under grants 1955805 and 2030859.

### BACKGROUND

Data about users is collected almost continually by phones, cameras, Internet websites, and other electronic devices. The advent of so-called ‘Smart Things’ or the Internet of Things (IoT) now enables ever-more sensitive data to be collected about a local environment, and that data can be used to infer characteristics about nearby people. As the number of deployed devices grows, it will become increasingly difficult for people to know if they are being observed by these devices. This problem is particularly salient as people become the occupants (perhaps temporarily) of a new space such as a hotel, conference room, or rental unit. In that case, the person may not be aware of all devices present in the environment. In some cases, devices such as hidden cameras may be purposely obscured to escape detection. Conversely in smart environments with dozens or hundreds of deployed devices, it may become extremely difficult for an administrator to maintain the location and status of every device in a space.

In addition to the security and privacy risks raised by the presence of IoT devices ubiquitously and unobtrusively collecting data, battery cells are a fire hazard in environments such as checked bags in airplanes as well as e-waste recycling plants. Moreover, separating batteries from electronic waste is critical for the correct extraction of precious metals from discarded electronics. Existing methods for detecting batteries in cluttered environments rely on expensive X-ray machines and computationally intense machine-learning techniques. The ability to detect batteries with less expensive equipment and in a more efficient manner be-comes increasingly important with the widespread propagation of battery powered IoT devices.

### SUMMARY

In an embodiment, a harmonic radar system for detecting batteries includes a signal generator for generating one or more transmit radio frequency (RF) signals, one or more low-pass filters for removing harmonics from the transmit RF signals, a transmitting antenna for sending the transmit RF signals into an environment, a receiving antenna for receiving signals reflected or re-radiated by batteries in the environment in response to the transmit RF signals, one or more high-pass filters for filtering the received signals, and a spectrum analyzer for identifying a harmonic frequency of the transmit RF signals in the filtered signals.

A method of using a harmonic radar system for detecting batteries includes generating a transmit TX carrier frequency signal, transmitting the TX carrier frequency signal into an environment including the electronic device, receiving a signal reflected or re-radiated by the battery in response to the TX carrier frequency signal, removing environmental and system-generated noise from received signal, and identifying a harmonic frequency of the TX carrier frequency signal in the received signal.

Throughout the disclosure, the terms energy storage device, battery cell and battery may be used interchangeably.

### BRIEF DESCRIPTION OF THE FIGURES

FIG. 1A is a representative diagram of an equivalent metal-oxide-metal (MOM) circuit.

FIG. 1B is a representative diagram of an MOM junction found in battery cathodes.

FIG. 2 is a block diagram of a harmonic radar system 100 for detecting batteries, in embodiments.

FIG. 3 is a flowchart of a method of detecting a battery using the system of FIG. 2, in embodiments.

FIG. 4 is a graph of average received signal power, in embodiments.

FIGS. 5A-5C are graphs of harmonic response of reference signals, in embodiments.

FIGS. 6A-6F are graphs of harmonic response of standalone battery cells, in embodiments.

FIG. 7 is a graph illustrating frequency response at different frequencies, in embodiments.

### DETAILED DESCRIPTION

Electronic devices that have computational and communication capabilities enabling them to collect and share information about their environment are becoming fully integrated into the daily lives of many users. Often referred to as “smart” devices, they are becoming a common fixture in many different types of environments—and yet their presence may not be readily apparent. Smart devices may include easy-to-spot smart assistants, however, they also include devices that are more difficult to visually detect due to their similarity in appearance to non-smart devices, such as smart light bulbs, smart door locks, or smart refrigerators. Other devices, such as surveillance cameras and microphones, may be purposefully located in difficult-to-observe locations to collect data without making their presence known.

Traditional radar may be used to detect devices in an environment by transmitting an RF signal toward a target. A portion of that signal is reflected or re-radiated from the outer portion or the encasing of the target. Assuming an otherwise empty environment, reflection indicates target detection and the time delay between TX (transmission) and RX (reception) is used to compute the range from the radar to the target. Traditional radar is linear; the set of frequencies reflected or re-radiated from the target is the same as frequencies transmitted, except for a slight difference imparted by relative motion between the target and the radar (the Doppler shift).

A major challenge in using a radar-like system to detect electronic devices in a cluttered environment such as a home or office is that the vast majority of objects in a typical environment generate a linear response so that the reflection of small electronics will be inter-mixed with reflections from walls, furniture, and people, among other obstacles. These linear responses arrive superimposed at the receiver. At best, using radar for electronic device detection and identification requires heavy use of signal-processing techniques to declutter the return signal. In practice, even with strong algorithms it would be challenging to detect and identify the footprint of a small electronic target device amid all the clutter. Moreover, traditional radars detect targets by the reflection from their “enclosure” or outer shell, making it difficult to detect items that might be intentionally hidden (or lost and out of sight).

Harmonic radar is a technology that may be used to discover all types of smart devices in a home—even those that are powered off. It may work irrespective of the device's communication protocols and may be able to detect malicious devices attempting to evade detection.

Harmonic radars work differently from linear radar. In particular, harmonic radar takes advantage of the nonlinear response of certain devices and substances to an RF signal. A harmonic radar system transmits a signal at a known frequency f₀ and listens for a return signal on a harmonic of the transmitted frequency (e.g., nf₀, where n is a positive integer greater than one). When the transmitted signal encounters a nonlinear junction (which is common in electronic devices, see below), the nonlinear junction reflects or re-radiates the transmitted signal at harmonic frequencies related to the transmitted signal. When the transmitted signal encounters obstacles that lack a nonlinear junction, this reflection or re-radiation does not occur. This reflection or re-radiation characteristic may be leveraged by transmitting one or more frequencies while listening for reflections or re-radiations on the harmonics of the transmitted signals. The reflected or re-radiated power of the harmonic has an inverse relationship with its associated integer (lower values of n provide higher received power, higher values of n provide lower received power); descriptions herein use the first harmonic where n=2 (but other values for n could be used) and the RX frequency is 2f₀.

Digital computation, even for simple devices like embedded systems, relies on semiconductors and other components that reflect or re-radiate RF signals nonlinearly. Harmonic radar systems are able to detect these devices and to identify them with high accuracy as described in Provisional Patent Application 63/522,236 filed Jun. 21, 2023, and titled “Harmonic Radar Scanner for Electronics,” incorporated herein by reference.

Harmonic radar can suffer from a problem: corrosion on targets can lead to false detection. Specifically, metal oxides such as rust also have a nonlinear RF behavior. This behavior, however, suggests an avenue for remotely detecting batteries. Commercially available battery cells contain metal oxides in the cathodes. In addition to electronic devices that reflect or re-radiate RF signals nonlinearly, metal oxides such as rust also have a nonlinear RF behavior. Since many types of commercially available batteries and battery cells contain metal oxides, this battery composition and its resulting nonlinear oxides are detectable by a harmonic radar.

Prior research into the nonlinear behavior of Lithium-Ion batteries has involved connecting batteries over a wire and leveraging the nonlinear behavior of the batteries' chemical processes. For example, the “state-of-health” of the batteries may be estimated by applying a high-amplitude sinusoidal input signal through a wire connected directly to the battery system and measuring changes in the sinusoidal output voltage over time and estimate the loss capacity fade due to loss of active material. Other research discusses the nonlinear behavior of Lithium-Ion batteries in the context of their electrochemical reactions during charge and discharge. Thus, the frequencies studied are limited to those associated with the chemical reactions.

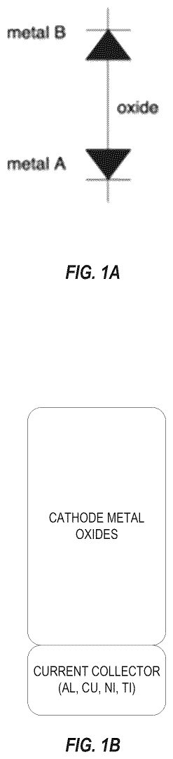

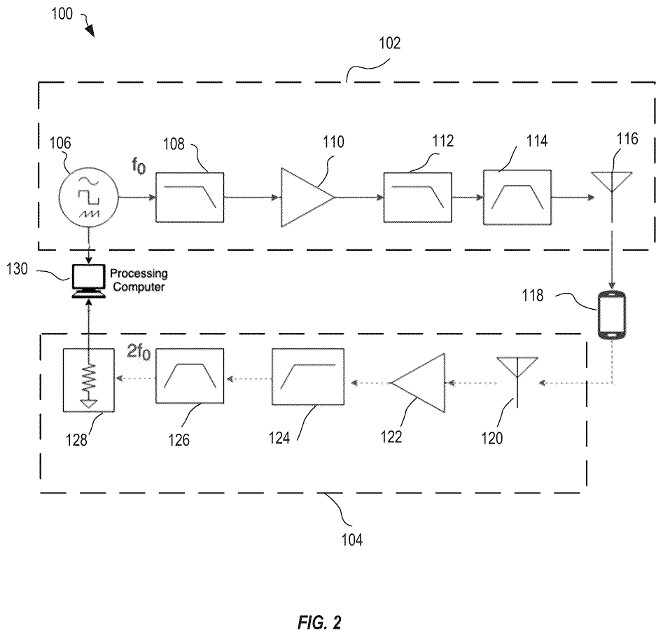

The metal-oxide-metal junction created by corrosion of a metal can be modeled by the circuit shown in FIG. 1A. The junction between a battery cell's cathode and the current collector follows a similar structure, as depicted in FIG. 1B; hence, a battery cell's cathode-collector boundary is modeled with the equivalent circuit in FIG. 1A, with harmonic responses comparable to corroded metals. A harmonic radar may be used to remotely detect the presence of batteries using RF by levering the batteries' physical structure.

In embodiments, a harmonic radar is used to detect many different types of batteries, such as Alkaline, NiMH, Li-ion, and Li-metal.

Various hardware devices are described herein, for example, signal generators, spectrum analyzers, filters and antennas. These devices are representative examples to illustrate principles disclosed herein but other devices and implementations may be used.

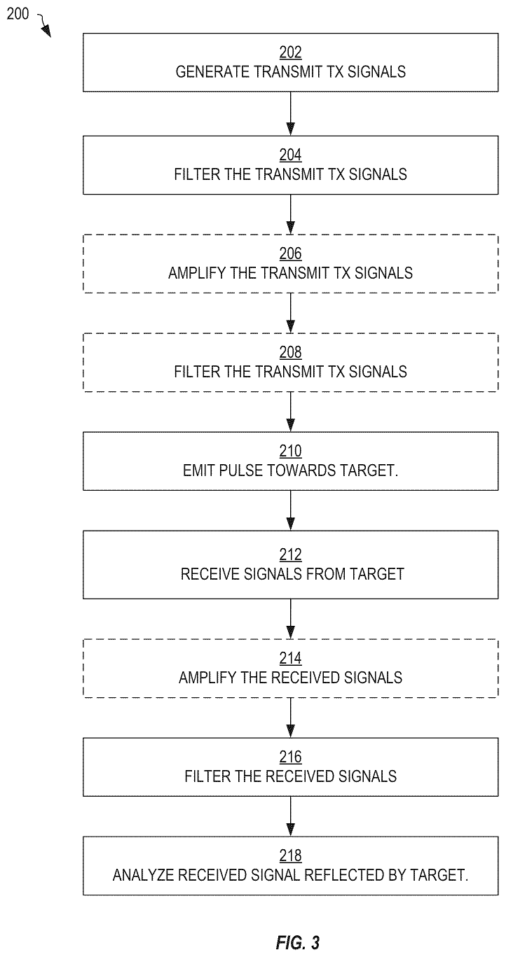

FIG. 2 is a block diagram of a harmonic radar system 100 for detecting batteries. The system can be generally divided into two blocks, transmitter block (TX) 102 and receiver block (RX) 104. TX block 102 includes signal generator 106 which may generate signals with a range between approximately 50 MHz and 6 GHz, for example, although other frequencies may be used. In embodiments, signal generator may be a Signal Hound VSG60A, for example. Signal f₀ from signal generator 106 is received by low-pass filter 108. Low-pass filter 108 may be a MiniCircuits SLP-2950+, which blocks harmonics produced by signal generator 106.

In embodiments, TX block 102 includes power amplifier module 110 to increase the signal's amplitude. Power amplifier module 110 may be an SBB5089+SZA2044 with a 40 dB gain, for example. In further embodiments, TX block 102 includes low pass reflection-less filter 112, such as a MiniCircuits ZXLF-K312H+, and bandpass filter 114, such as an HP 8431A, to attenuate harmonics produced by power amplifier module 110 before the signal is transmitted by antenna 116.

The RF signal transmitted by antenna 116 encounters target 118. Signals reflected or re-radiated by target 118 are received at antenna 120 of RX block 104. The relative positions of antennas 116 and 120 and target 118 are for purposes of illustration only.

In embodiments, the signal received at antenna 120 is sent to amplifier 122, such as a TQP3M9037 LNA, which amplifies the received signal. One or more filters 124 and 126, such as a MiniCircuits VHF-3800+high-pass filter and a HP 8435A band-pass filter attenuate any scattering at the transmitted (fundamental) frequency. Spectrum analyzer 128, such as a SignalHound BB60C, collects the received signal.

In embodiments, antennas 116 and 120 may be a LP0965 Log Periodic directional antenna for wireless transmission, and a BNC cable is used to connect the trigger channels of both TX block 102 and RX block 104 for synchronization. In embodiments, transmit antenna 116 and receive antenna 120 of FIG. 2 may be a single antenna connected to a coupler. Both signal generator 106 and spectrum analyzer 128 are coupled to processing computer 130.

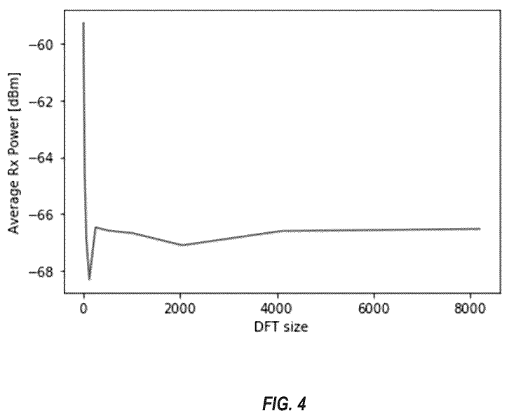

FIG. 3 is a flowchart of a method 200 of detecting a battery using the system of FIG. 2. Method 200 includes steps 202, 204, 210, 212, 216 and 218. In embodiments, method 200 also includes at least one of steps 206, 208 or 214. As discussed herein, the terms “capture” or “measurements” denote obtained data.

In step 202, a TX carrier frequency signal is generated. In an example of step 202, signal generator 106 is set to generate the TX carrier frequency f₀ at a power level of −20 dBm. The TX power level (−20 dBm) is selected so any unintended harmonic emissions are kept below the RF noise floor, as determined by previously acquired reference signals.

In step 204, the TX carrier frequency signal is filtered. In an example of step 204, low-pass reflection-less filter 108 is used to remove harmonics.

In step 206, the filtered TX carrier frequency signal is amplified. In an example of step 206, the filtered TX carrier frequency signal is amplified using power amplifier module 110.

In step 208, the amplified signal is filtered. In an example of step 208, the amplified TX carrier frequency signal is filtered by one or more filters such as filter 112 or filter 114 to remove harmonics produced through amplification.

In step 210, the TX carrier frequency signal is emitted towards a target. In an example of step 210, the TX carrier frequency signal is transmitted by antenna 116 into an environment including a battery. Signal generator 106 is set to emit a 0.6 ms Continuous Wave (CW) pulse. The trigger channel is pulled “high” until transmission ends, and spectrum analyzer 128 is set to capture twice as long (1.2 ms) to avoid missing the pulse. The length of the transmitted pulse may be selected experimentally to minimize the acquisition time and raw data size.

In step 212, a signal reflected or re-radiated by the battery in response to the TX carrier frequency signal is received. In an example of step 212, the RX carrier frequency is set to 2 f₀ and the maximum receive power level to 0 dBm.

In step 214, the received signal is amplified. In an example of step 214, the received signal is amplified by amplifier 122.

In step 216, the amplified signal is filtered. In an example of step 216, One or more filters 124 and 126, are used to remove environmental and system-generated noise from received signal.

In step 218, the received signal reflected or re-radiated by the target is analyzed. In an example of step 218, a flat-top window is applied to RX-captured IQ data and used to calculate a Discrete Fourier Transform (DFT).

In embodiments, the signal strengths for all harmonic responses are determined by averaging the power spectrum over 10 “captures.”

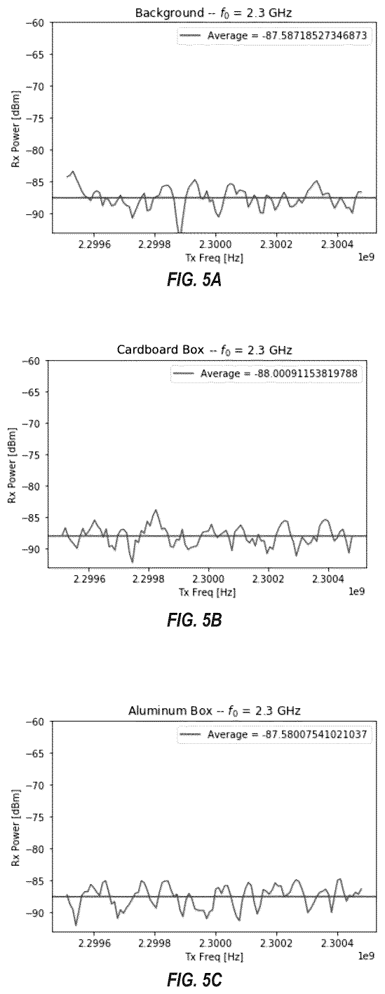

In data processing, the DFT window is the most important design parameter. Harmonic radar detection is heavily dependent on changes of received power, so in embodiments, a flat-top window is applied, to produce more accurate amplitude estimates, before computing the transform with the DFT algorithm. Although the received peak power is not dependent on the pulse length, the power estimated from the DFT is affected by the DFT window length. Using measurements taken on a very responsive nonlinear target, such as an iPhone 13 Pro Max, different window sizes may be evaluated. As shown in FIG. 4, the power estimate plateaus at a 4000-point window; thus, the closest power of two (i.e., 4096 points) may be chosen for the DFT window size. The DFT algorithm takes advantage of symmetries that result from windows with a size that is a power of 2.

For peak detection, the maximum value in a bin is chosen. This method is simple, fast, and accurate. This method may result in an incorrect frequency bin selection (i.e., the maximum peak may not always be at the same bin); since the frequency is known beforehand, it is only necessary to look at the neighboring bins within the spectrum analyzer and signal generator errors. In embodiments disclosed herein spectrum analyzer 128 and signal generator 106 both have a reported error of 2.0 ppm, which results in around 7 KHz of uncertainty from the set frequencies: 2.3 GHZ (TX) and 4.6 GHz (RX). In the worst-case scenario, with maximum uncertainty in both generator and analyzer, there can be 14 KHz uncertainty in the DFT center frequency; with the selected DFT size (4096), the frequency resolution is 9.8 KHz; hence, examination of only three bins is needed to find the maximum peak, that of the center frequency (bin 0) as well as the two closest neighbors (bin-1 and bin 1).

In embodiments, f₀=2.3 GHZ. In general, the harmonic response of consumer electronics is maximal in the region around 2.4 GHz due to the operation frequency range of the target devices. As disclosed herein, a slightly different frequency from f₀=2.3 GHz may be used to avoid any potential Wi-Fi or Bluetooth interference.

Device detection mechanisms based on harmonic radar technology are dependent on differences between the background environment (e.g., no target device present) and the signal received from a target device. As used in this representative example, ‘detection’ means that observed response was at least 3 dBm higher (i.e., double the power) than the background environment. This threshold represents the worst-case detection scenario.

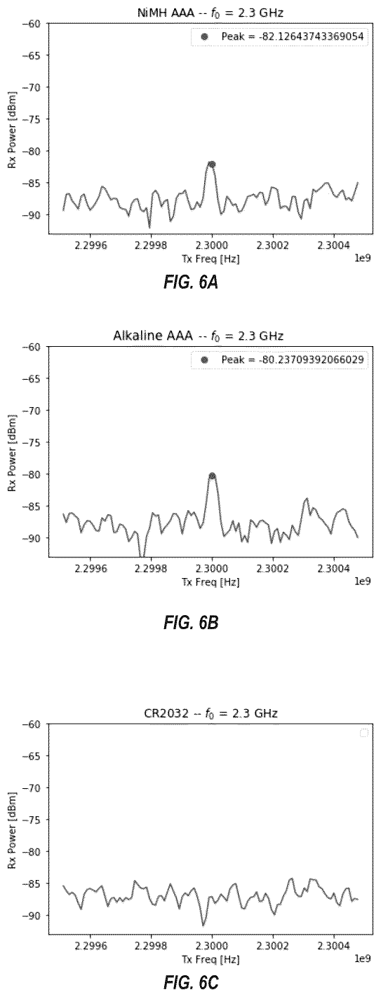

FIGS. 5A-5C are graphs of harmonic response of reference signals, in embodiments and summarize the measured average RX power for the reference signals when testing non-battery targets. To differentiate batteries from other objects, three non-battery target configurations were evaluated: a background response with no objects present, a cardboard box representing a non-reflective object, and an aluminum foil coated box representing a highly reflective object. This test served to quantify the environmental and system generated noise without a target device. Because these reference items do not contain nonlinear junctions, we expected them to display no nonlinear response. Results are shown in FIGS. 5A-5C for f₀ is set to 2.3 GHZ.

The noise floor of the system is estimated to be −87.6±1.7 dBm as shown by the background capture in FIG. 5A. Additionally, the cardboard and aluminum responses, FIGS. 5B and 5C, respectively, serve as a reliability indicator for the chosen frequency and power settings as well as the correct operation of the radar overall. One of the major sources of error for harmonic radars is the reflection of “leaked” energy at 2f0 generated by the nonlinear components in the circuit. The fact that both references are within the expected deviation from the average background (e.g., they did not have a harmonic response) confirmed the harmonic radar was working as intended.

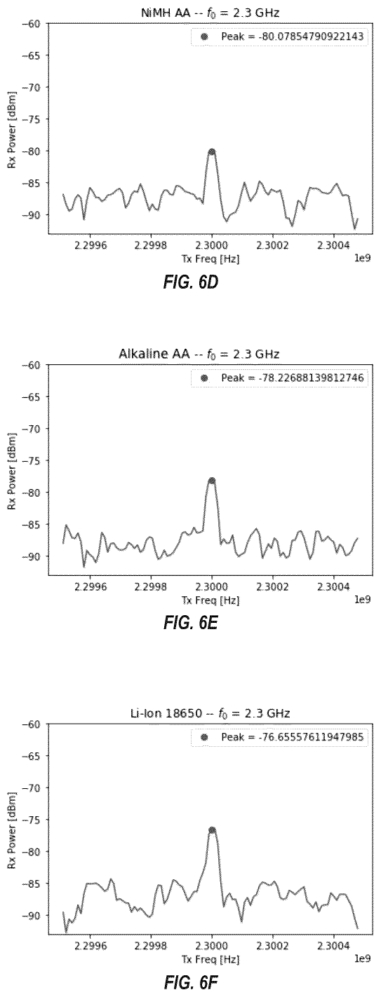

FIGS. 6A-6F are graphs of harmonic response of standalone battery cells and show that the harmonic radar easily detected the batteries using the system of FIG. 2 with a 3 dBm threshold, except for the CR2032 coin cell. This may have been due to the battery's small size. A lower threshold (less than 3 dBm) could have been used to detect the coin cell. The results are summarized in Table 1 below. The larger the battery (e.g., AA vs. AAA), the higher the average response. For example, the NiMH AA battery had an average response of −80.0 dBm as shown in FIG. 6D, but the AAA form factor only had an average response of −82.1 dBm as shown in FIG. 6A. Due to decibel's nonlinear scale, 3 dBm is a half power point, suggesting the difference of 2.1 dBm may be significant.

TABLE 1

| | Response | |
|---|---|---|
| Battery Type | (dBm) | Difference |
| Background | −87.6 | 0.0 |
| NiMH AAA | −82.1 | 5.5 |
| Alkaline AAA | −80.2 | 7.4 |
| CR2032 | −86.1 | 1.5 |
| NiMH AA | −80.0 | 7.6 |
| Alkaline AA | −78.2 | 9.4 |
| Li-Ion 18650 | −76.6 | 11.0 |
| Nexus S Li-Ion | −80.6 | 7.0 |

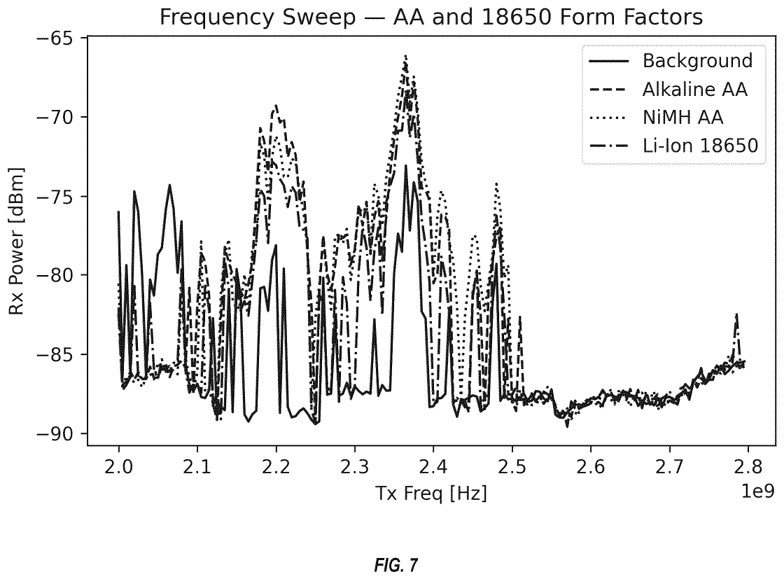

Although representative frequencies have been discussed, this is for purposes of illustration and other frequencies may be used by harmonic radar systems 100. For example, FIG. 7 depicts the results using the system of FIG. 2 with a range of f0 values, for three batteries (Alkaline AA, NiMH AA, Li-Ion 18650). The batteries do not show much difference in response across the tested frequencies. Small differences in power can be observed throughout the spectrum; such differences, however, cannot be used to distinguish battery types and form factors since they can be easily counteracted by changing the relative distance between battery cells and the radar's antennas

Embodiments discussed herein include harmonic radar systems capable of detecting the presence of battery cells. This may become handy in situations where batteries, on their own, represent a security threat-such as checked bags containing Li-Ion batteries in airplanes, or situations where batteries might need to be detected amid other “linear clutter” such as in recycling plants.

Changes may be made in the above methods and systems without departing from the scope hereof. For example, although a range of frequencies f₀ has been discussed as determined by the capabilities of the harmonic radar hardware. Although these frequencies seem suitable for the detection of consumer-grade electronics, other frequencies may be used. Further, increased maximum detection ranges may be possible. Combined device and battery systems: Nonlinear junctions found in electronic devices (i.e., transistors) are known to have a measurable harmonic response. Although our results show that batteries, by themselves, produce a measurable harmonic response, we have not tested the ability of the system to detect batteries installed in electronics. The presence of nonlinear components in electronics may mask or amplify a target's harmonic response.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A harmonic radar system for detecting a battery, comprising:
a signal generator for generating one or more transmit radio frequency (RF) signals;
one or more low-pass filters for removing harmonics from the transmit RF signals;
a transmitting antenna for sending the transmit RF signals into an environment;
a receiving antenna for receiving signals reflected or re-radiated by the battery in the environment in response to the transmit RF signals;
one or more high-pass filters for filtering the received signals; and
a spectrum analyzer for identifying a harmonic frequency of the transmit RF signals in the filtered signals.

2. The harmonic radar system of claim 1, wherein at least one of the low-pass filters is a reflection-less filter.

3. The harmonic radar system of claim 1, comprising a transmitting amplifier coupled between the signal generator and the transmitting antenna.

4. The harmonic radar system of claim 1, comprising a receiving amplifier.

5. The harmonic radar system of claim 1, wherein the signal generator generates signals between approximately 50 MHz and 6 GHz.

6. The harmonic radar system of claim 1, wherein a center frequency of one or more transmit RF signals is f₀=2.3 GHZ.

7. The harmonic radar system of claim 1, further comprising a processing computer coupled to the signal generator and spectrum analyzer.

8. A method of using a harmonic radar system for detecting a battery, comprising:
generating a transmit TX carrier frequency signal;
filtering the TX carrier frequency signal to remove harmonics;
transmitting the TX carrier frequency signal into an environment including the battery receiving a signal reflected or re-radiated by the battery in response to the TX carrier frequency signal;
removing environmental and system-generated noise from received signal; and
identifying a harmonic frequency of the TX carrier frequency signal in the received signal.

9. The method of claim 8, wherein the TX carrier frequency signal comprises f₀=2.3 GHZ.

10. The method of claim 8, wherein a receive (RX) carrier frequency is set to 2f₀ GHz.

11. The method of claim 8, wherein filtering the TX carrier frequency signal to remove harmonics includes using a low-pass reflection-less filter.

12. The method of claim 11, further comprising amplifying the filtered TX carrier frequency signal.

13. The method of claim 12, further comprising filtering the amplified TX carrier frequency signal to remove harmonics produced through amplification.

14. The method of claim 8, wherein removing environmental and system-generated noise from received signal further comprises filtering the received signal.

15. The method of claim 14, further comprising amplifying the received signal before removing environmental and system-generated noise.
